(19) United States
(12) Patent Application Publication
(10) Pub. No.: US 2012/0239329 A1
(43) Pub. Date: Sep. 20, 2012

(54) SAGNAC PHASE SHIFT TRACKING METHOD FOR FIBER-OPTIC GYROSCOPES

(75) Inventors: Chuanchuan Yang, Beijing (CN); Ziyu Wang, Beijing (CN)

(73) Assignee: University, Peking, Beijing (CN)

(21) Appl. No.: 13/218,366

(22) Filed: Aug. 25, 2011

Related U.S. Application Data
(63) Continuation-in-part of application No. PCT/CN2011/071892, filed on Mar. 17, 2011.

(30) Foreign Application Priority Data
Mar. 15, 2011 (CN) CN 201110061984.0

(51) Int. Cl. G01C 19/72; G06F 19/00

(52) U.S. Cl. 702/72; 356/460; 356/461

(57) ABSTRACT

A Sagnac phase shift tracking method of fiber-optic gyroscopes comprises determining, for both a current time and a previous time, a value of a primary harmonic demodulated signal and a value of a secondary harmonic demodulated signal from a detector output in the fiber-optic gyroscope; and determining the Sagnac phase shift of the fiber-optic gyroscope for the current time based on the values of the primary harmonic demodulated signal and the secondary harmonic demodulated signal for both the current time and the previous time.

This is a continuation-in-part of PCT international application no. PCT/CN2011/071892, filed on Mar. 17, 2011, which claims priority to Chinese patent application no. CN 201110061984.0 filed on Mar. 15, 2011.

### TECHNICAL FIELD OF THE INVENTION

The invention belongs to the fiber-optic sensing field, and particularly relates to a Sagnac phase shift tracking method for fiber-optic gyroscopes.

### BACKGROUND

Fiber-optic sensing technology is a novel sensing technology paid close attention extensively. As one of the most important accomplishments of fiber-optic sensing field, fiber-optic gyroscopes are widely researched and applied at present. Fiber-optic gyroscopes are angular-velocity measuring instruments based on Sagnac effect and have many feasible working modes such as resonant mode, interferometric mode and slow-light mode; at present, fiber-optic gyroscopes that have mature techniques and large-scale applications are interferometric fiber-optic gyroscopes. Interferometric fiber-optic gyroscopes have two basic structures: open-loop structure and closed-loop structure.

As open-loop fiber-optic gyroscopes directly detect Sagnac phase shift in optic paths, the operation points of the system change along with the input angular-velocity; closed-loop fiber-optic gyroscopes offset Sagnac phase shift in optic paths by feedback loops and take feedback signals as detection signals; therefore the operation points of the system do not change along with the input angular-velocity. Based on such working principles, these two kinds of fiber-optic gyroscopes have their advantages and disadvantages: by comparison, the closed-loop fiber-optic gyroscopes have outstanding advantages of higher scale factor stability, larger dynamic range and less drift; as open-loop fiber-optic gyroscopes do not use feedback loops, they have better temperature resistance, mechanical compact and mechanical vibration resistant performances, better electromagnetic interference resistant performance, higher reliability and lower production, and use and maintenance costs. See Reference: Zhang Guicai, Principles and Techniques of Fiber-optic Gyroscopes, National Defense Industry Press, 2008.

Along with the rapid development of electronic technology and software engineering technology, signal processing technology emerges and has been rapidly developed. The invention proposes a signal processing method applied at the backend of fiber-optic gyroscope detectors; when this technology is used in open-loop fiber-optic gyroscopes, the dynamic ranges of open-loop fiber-optic gyroscopes can reach the same level as the close-loop fiber-optic gyroscopes. Based on the technology, new generation fiber-optic gyroscopes having advantages of both open-loop fiber-optic gyroscopes and closed-loop fiber-optic gyroscopes can be derived.

The basic structure diagram of open-loop fiber-optic gyroscopes is shown in FIG. 1, and the detection signal output by the detector (module 5) is

I_{D}(t)=I₀{1+cos [φₛ+Δφ(t)]} (1)

wherein φₛ is a Sagnac phase shift, I₀ is an average power of detection signal, and Δφ(t) is determined by an output signal of the phase modulator (module 4).

General open-loop fiber-optic gyroscopes employ PZT phase modulators, as PZT phase modulators have narrow frequency bands, most open-loop fiber-optic gyroscopes adopt sinusoidal phase modulation; thus the following formula can be obtained:

$$Δϕ ( t ) = 2 {ϕ}_{m} sin ( \frac{{ω}_{m} τ}{2} ) cos [ {ω}_{m} ( t - \frac{τ}{2} ) ] \qquad ( 2 )$$

wherein φₘ is a modulation amplitude, ωₘ is a modulation frequency, τ is a transmission time that light passes through coil 3.

Formula (2) is brought into formula (1) and Bessel function is used to expand the detection signal I_{D}(t), the following formula is obtained:

$${I}_{D} ( t ) = {I}_{0} \{ 1 + [ {J}_{0} ( {η}_{ϕ} ) + 2 \sum {( - 1 )}^{n} {J}_{2 n} ( {η}_{ϕ} ) cos 2 n {ω}_{m} ( t - \frac{τ}{2} ) ] cos {ϕ}_{s} + 2 \sum {( - 1 )}^{n + 1} {J}_{2 n - 1} ( {η}_{ϕ} ) sin [ ( 2 n - 1 ) {ω}_{m} ( t - \frac{τ}{2} ) ] sin {ϕ}_{s} \} \qquad ( 3 )$$

wherein n is an integer, Jₙ is the order-n Bessel function of the first kind of η_{φ}, and

$${η}_{ϕ} = 2 {ϕ}_{m} sin ( \frac{{ω}_{m} τ}{2} ) .$$

From the above formula, it can be found that the detection signal contains base band signal of the phase modulation signal and harmonic signals. The output signal of fiber-optic gyroscopes can be obtained by detecting a primary harmonic wave of I_{D}(t):

Iₒᵤₜ(t)∝I₀ sin φₛ (4)

from formula (4), it can be found that the dynamic range of open-loop fiber-optic gyroscopes is the monotone interval [−π/2 π/2) of sine function, maximally. The relation expression of Sagnac phase shift φₛ, of open-loop fiber-optic gyroscopes and system rotating angular-velocity Ω is:

$${ϕ}_{s} = \frac{4 π RL}{\overline{λ} c} Ω \qquad ( 5 )$$

wherein λ̅ is an average wavelength of the light source (module 1), c is a transmission speed of light in vacuum, R is a radius of the fiber-optic coil (module 3), and L is a length of the fiber-optic coil. Subject to the monotone interval of sine function, when formula (5) is brought into formula (4), the maximum dynamic range

$$[ - \frac{\overline{λ} c}{8 RL} \frac{\overline{λ} c}{8 RL} )$$

of angular-velocity Ω that can be measured by open-loop fiber-optic gyroscopes can be obtained.

From the above analysis, it can be found that the dynamic range of open-loop fiber-optic gyroscopes is in inverse proportion to the radius and length of coils, in combination with formula (5), increasing the dynamic range of open-loop fiber-optic gyroscopes results in decreasing of the Sagnac phase shift caused by rotation of the system, which further decreases the sensitivity and precision of gyroscopes.

In order to increase the dynamic range of open-loop fiber-optic gyroscopes, a published invention patent with application No. 200710160367.X proposes a method, in which a phase modulator is used for modulating phases of fiber-optic gyroscopes with many different amplitudes, output signals of corresponding gyroscopes are sampled, and data are processed and combined in order to achieve the purpose of expanding the monotone interval range of open-loop fiber-optic gyroscopes. In the invention patent with application No. 200710160367.X, the monotone Sagnac phase shift interval that can be measured by open-loop fiber-optic gyroscopes is expanded to [−23π/16 23π/16) from [−π/2 π/2) mentioned in the above analysis text by signal processing, that is, it is expanded by 23/8 times; however, the key point of this invention is that the phase modulator no longer operates in the above described normal state, instead, it operates at five modulation phases within a modulation period, each phase has different but fixed modulation amplitude; thus, the modulation signal output by the phase modulator needs high precision, the modulation amplitude needs strict control, and any error of the modulation signal will influence the whole implementation effect of the invention.

### SUMMARY

The purpose of the invention is to propose a Sagnac phase shift tracking method of fiber-optic gyroscopes, Sagnac phase shift tracking, which can be applied at the backend of detectors, greatly increases the dynamic range of fiber-optic gyroscopes without changing the structure of open-loop fiber-optic gyroscopes and decreasing the precision of gyroscopes; in the invention, the dynamic range of gyroscopes is no longer related to the dimension parameters of coils, the precision and scale factor linearity of fiber-optic gyroscopes can be further improved, and novel fiber-optic gyroscopes having advantages of both open-loop fiber-optic gyroscopes and closed-loop fiber-optic gyroscopes can be derived.

The technical solution of the invention in one embodiment is as follows:

A Sagnac phase shift tracking method of a fiber-optic gyroscope is proposed, wherein the fiber-optic gyroscope is configured as follows: a laser light source is connected with a polarizer through a coupler 31, the polarizer is connected with a fiber-optic ring through a coupler 32, a phase modulator is connected between the fiber-optic ring and the coupler 32, the other port of the coupler 31 is connected with a detector and the detector and the laser light source are positioned at the same side of the coupler 31, the output end of the detector is connected with the control end of the phase modulator through a filtering and analog-to-digital conversion module, a signal processing module, a digital-to-analog conversion module in sequence; the method comprises the following steps:
1) filtering and demodulating a detection signal sampled at time of k=0 to obtain a primary harmonic wave demodulation signal S₁(0) and a secondary harmonic demodulation signal S₂(0) of the detection signal at time of k=0, wherein k is the sampling time;
2) calculating to obtain the Sagnac phase shift φₛ(0) of the fiber-optic gyroscope at time of k=0 according to S₁(0) and S₂(0), and initializing an initial value of a phase offset parameter PB as 0;
3) filtering and demodulating the detection signal sampled at the subsequent time k to obtain a primary harmonic wave demodulation signal S₁(k) and a second harmonic demodulation signal S₂(k) at a current time; and determining a Sagnac phase shift value φₛ(k) at the current time according to S₁(k) and S₂(k) as well as the primary harmonic wave demodulation signal S₁(k−1) and the secondary harmonic demodulation signal S₂(k−1) at the previous time.

Further, the method for determining the Sagnac phase shift value φₛ(k) at the current time in one embodiment is as follows:
a) first, judging whether S₁(k−1)S₂(k−1)S₁(k)S₂(k) is less than 0, if so, carrying out Step b), otherwise, directly outputting a Sagnac phase shift measurement value

$${ϕ}_{s} ( k ) = {tan}^{- 1} ( \frac{{S}_{1} ( k )}{{S}_{2} ( k )} ) + PB ;$$

b) if S₁(k)S₂(k−1)−S₂(k)S₁(k−1) is greater than 0, when S₁(k−1)S₂(k−1) is greater than 0, updating the parameter PB as PB+π and then outputting

$${ϕ}_{s} ( k ) = {tan}^{- 1} ( \frac{{S}_{1} ( k )}{{S}_{2} ( k )} ) + PB ,$$

otherwise directly outputting

$${ϕ}_{s} ( k ) = {tan}^{- 1} ( \frac{{S}_{1} ( k )}{{S}_{2} ( k )} ) + PB ;$$

if S₁(k)S₂(k−1)−S₂(k)S₁(k−1) is not greater than 0, when S₁(k−1)S₂(k−1) is less than 0, updating the parameter PB as PB−π and then outputting

$${ϕ}_{s} ( k ) = {tan}^{- 1} ( \frac{{S}_{1} ( k )}{{S}_{2} ( k )} ) + PB ,$$

otherwise, directly outputting

$${ϕ}_{s} ( k ) = {tan}^{- 1} ( \frac{{S}_{1} ( k )}{{S}_{2} ( k )} ) + PB .$$

Further, the method for determining the Sagnac phase shift value φₛ(k) at the current time is as follows:
a) first, judging whether S₁(k−1)S₂(k−1)S₁(k)S₂(k) is less than 0, if so, carrying out Step b), otherwise, carrying out Step c);
b) if S₁(k)S₂(k−1)−S₂(k)S₁(k−1) is greater than 0, when S₁(k−1)S₂(k−1) is greater than 0, updating the parameter PB as PB+π and then outputting

$${ϕ}_{s} ( k ) = - \frac{π}{2} - {tan}^{- 1} ( \frac{{S}_{2} ( k )}{{S}_{1} ( k )} ) + PB ,$$

otherwise directly outputting

$${ϕ}_{s} ( k ) = {tan}^{- 1} ( \frac{{S}_{1} ( k )}{{S}_{2} ( k )} ) + PB ;$$

if S₁(k)S₂(k−1)−S₂(k)S₁(k−1) is not greater than 0, when S₁(k−1)S₂(k−1) is less than 0, updating the parameter PB as PB−π and then outputting

$${ϕ}_{s} ( k ) = \frac{π}{2} - {tan}^{- 1} ( \frac{{S}_{2} ( k )}{{S}_{1} ( k )} ) + PB ,$$

otherwise, directly outputting

$${ϕ}_{s} ( k ) = {tan}^{- 1} ( \frac{{S}_{1} ( k )}{{S}_{2} ( k )} ) + PB ;$$

c) if |S₁(k)|>|S₂(k)|, when S₁(k) is greater than 0, outputting

$${ϕ}_{s} ( k ) = \frac{π}{2} - {tan}^{- 1} ( \frac{{S}_{2} ( k )}{{S}_{1} ( k )} ) + PB ,$$

otherwise, directly outputting

$${ϕ}_{s} ( k ) = - \frac{π}{2} - {tan}^{- 1} ( \frac{{S}_{2} ( k )}{{S}_{1} ( k )} ) + PB ;$$

if |S₁(k)|≦|S₂(k)|, directly outputting

$${ϕ}_{s} ( k ) = {tan}^{- 1} ( \frac{{S}_{1} ( k )}{{S}_{2} ( k )} ) + PB .$$

Further, the Sagnac phase shift φₛ(0) at time of k=0 is calculated according to a formula

$${ϕ}_{s} ( 0 ) = {tan}^{- 1} ( \frac{{S}_{1} ( 0 )}{{S}_{2} ( 0 )} ) .$$

Further, the output end of the detector is connected with the input end of the filtering and analog-to-digital conversion module through an amplifier.

A Sagnac phase shift tracking method of a fiber-optic gyroscope is proposed, wherein in one embodiment the fiber-optic gyroscope is configured as follows: a laser light source is connected with a polarizer through a coupler 31, the polarizer is connected with a fiber-optic ring through a coupler 32, a phase modulator is connected between the fiber-optic ring and the coupler 32, the other port of the coupler 31 is connected with a detector and the detector and the laser light source are positioned at the same side of the coupler 31, the output end of the detector is connected with the input end of a filter, the output end of the filter is respectively connected with the input ends of a primary harmonic wave demodulation module and a secondary harmonic demodulation module, the output ends of the primary harmonic wave demodulation module and the secondary harmonic demodulation module are connected with a signal processing module through an analog-to-digital conversion module; the control ends of the phase modulator and the primary harmonic wave demodulation module are respectively connected with the output end of an oscillator; the control end of the second harmonic demodulation module is connected with the output end of the oscillator through a 90° phase shift and frequency multiplication module; the method comprises the following steps:
1) filtering, demodulating a detection signal and sampling the detection signal at time of k=0 to obtain a primary harmonic wave demodulation signal S₁(0) and a secondary harmonic demodulation signal S₂(0) of the detection signal at time of k=0, wherein k is the sampling time;
2) calculating to obtain the Sagnac phase shift φₛ(0) of the fiber-optic gyroscope at time of k=0 according to S₁(0) and S₂(0), and initializing an initial value of a phase offset parameter PB as 0;
3) filtering and demodulating the detection signal sampled at the subsequent time k to obtain a primary harmonic wave demodulation signal S₁(k) and a second harmonic demodulation signal S₂(k) at a current time; and determining a Sagnac phase shift value φₛ(k) at the current time according to S₁(k) and S₂(k) as well as the primary harmonic wave demodulation signal S₁(k−1) and the secondary harmonic demodulation signal S₂(k−1) at the previous time.

Further, the method for determining the Sagnac phase shift value φₛ(k) at the current time is as follows:
a) first, judging whether S₁(k−1)S₂(k−1)S₁(k)S₂(k) is less than 0, if so, carrying out Step b), otherwise, directly outputting a Sagnac phase shift measurement value

$${ϕ}_{s} ( k ) = {tan}^{- 1} ( \frac{{S}_{1} ( k )}{{S}_{2} ( k )} ) + PB ;$$

b) if S₁(k)S₂(k−1)−S₂(k)S₁(k−1) is greater than 0, when S_{I}(k−1)S₂(k−1) is greater than 0, updating the parameter PB as PB+π and then outputting

$${ϕ}_{s} ( k ) = {tan}^{- 1} ( \frac{{S}_{1} ( k )}{{S}_{2} ( k )} ) + PB ,$$

otherwise directly outputting

$${ϕ}_{s} ( k ) = {tan}^{- 1} ( \frac{{S}_{1} ( k )}{{S}_{2} ( k )} ) + PB ;$$

if S₁(k)S₂(k−1)−S₂(k)S₁(k−1) is not greater than 0, when S₁(k−1)S₂(k−1) is less than 0, updating the parameter PB as PB−π and then outputting

$${ϕ}_{s} ( k ) = {tan}^{- 1} ( \frac{{S}_{1} ( k )}{{S}_{2} ( k )} ) + PB ,$$

otherwise, directly outputting

$${ϕ}_{s} ( k ) = {tan}^{- 1} ( \frac{{S}_{1} ( k )}{{S}_{2} ( k )} ) + PB .$$

Further, the method for determining the Sagnac phase shift value φₛ(k) at the current time is as follows:
a) first, judging whether S₁(k−1)S₂(k−1)S₁(k)S₂(k) is less than 0, if so, carrying out Step b), otherwise, carrying out Step c);
b) if S₁(k)S₂(k−1)−S₂(k)S₁(k−1) is greater than 0, when S₁(k−1)S₂(k−1) is greater than 0, updating the parameter PB as PB+π and then outputting

$${ϕ}_{s} ( k ) = - \frac{π}{2} - {tan}^{- 1} ( \frac{{S}_{2} ( k )}{{S}_{1} ( k )} ) + PB ,$$

otherwise directly outputting

$${ϕ}_{s} ( k ) = {tan}^{- 1} ( \frac{{S}_{1} ( k )}{{S}_{2} ( k )} ) + PB ;$$

if S₁(k)S₂(k−1)−S₂(k)S₁(k−1) is not greater than 0, when S₁(k−1)S₂(k−1) is less than 0, updating the parameter PB as PB−π and then outputting

$${ϕ}_{s} ( k ) = \frac{π}{2} - {tan}^{- 1} ( \frac{{S}_{2} ( k )}{{S}_{1} ( k )} ) + PB ,$$

otherwise, directly outputting

$${ϕ}_{s} ( k ) = {tan}^{- 1} ( \frac{{S}_{1} ( k )}{{S}_{2} ( k )} ) + PB ;$$

c) if |S₁(k)|>|S₂(k)|, when S₁(k) is greater than 0, outputting

$${ϕ}_{s} ( k ) = \frac{π}{2} - {tan}^{- 1} ( \frac{{S}_{2} ( k )}{{S}_{1} ( k )} ) + PB ,$$

otherwise, directly outputting

$${ϕ}_{s} ( k ) = - \frac{π}{2} - {tan}^{- 1} ( \frac{{S}_{2} ( k )}{{S}_{1} ( k )} ) + PB ;$$

if |S₁(k)|≦|S₂(k)|, directly outputting

$${ϕ}_{s} ( k ) = {tan}^{- 1} ( \frac{{S}_{1} ( k )}{{S}_{2} ( k )} ) + PB .$$

Further, the Sagnac phase shift φₛ(0) at time of k=0 is calculated according to a formula

$${ϕ}_{s} ( 0 ) = {tan}^{- 1} \frac{{S}_{1} ( 0 )}{{S}_{2} ( 0 )} .$$

Further, the output end of the detector is connected with the input end of the filter through an amplifier.

The primary harmonic wave demodulation signal of the detection signal I_{D}(t) after sampling at time k is proportional to sin φₛ(k) and the secondary harmonic demodulation signal after sampling is proportional to cos φₛ(k), the two harmonic demodulation signals have different scale factors that can be respectively obtained by turntable calibration tests, during tests, the turntable provides a reference revolving speed, then the reference revolving speed is respectively divided by the revolving speeds detected by the primary and secondary harmonic demodulation signals to obtain the corresponding scale factors. The sampled primary harmonic demodulation signal and secondary harmonic demodulation signal are respectively divided by their corresponding scale factors to derive:

S₁(k)=C sin φₛ(k)

S₂(k)=C cos φₛ(k) (6)

where, C is a common coefficient.

The Sagnac phase shift tracking method proposed in the invention includes two phases: 1) initialization phase; and 2) tracking phase. Specific description is as follows:

STEP 1: initialization: at time of k=0, calculating Sagnac phase shift:

$${ϕ}_{s} ( 0 ) = {tan}^{- 1} \frac{{S}_{1} ( 0 )}{{S}_{2} ( 0 )} \qquad ( 7 )$$

at the same time, setting the initial value of phase offset PB=0.

STEP 2: tracking: for k=k+1, k=0, 1, 2 . . . , executing the Sagnac phase shift tracking algorithm shown in the flow chart of FIG. 2: initial parameters in the tracking step are set in the initialization phase STEP 1, the tracking algorithm executes judgment by getting values from a function that is formed by the primary and secondary harmonic demodulation signals at the current time and the primary and secondary harmonic demodulation signals at the previous time (achieves by judgment boxes 6, 7, 8 and 11), and determines the update value PB of phase offset at each step of tracking and the Sagnac phase shift measurement value φₛ(k) at each time (achieves by flow boxes 9, 10 and 12); first, judging whether value of function S₁(k−1)S₂(k−1)S₁(k)S₂(k) is less than 0 in the judgment box 6, if so, executing operation of judgment box 7, that is, judging whether value of function S₁(k)S₂(k−1)−S₂(k)S₁(k−1) is greater than 0, if it is not greater than 0, directly outputting the Sagnac phase shift measurement value

$${ϕ}_{s} ( k ) = {tan}^{- 1} ( \frac{{S}_{1} ( k )}{{S}_{2} ( k )} ) + PB ;$$

for the judgment box 7, if S₁(k)S₂(k−1)−S₂(k)S₁(k−1) is greater than 0, executing operation of judgment box 8, otherwise, executing operation of judgment box 11; for the judgment box 8, if S₁(k−1)S₂(k−1) is greater than 0, executing the flow box 9, updating parameter PB as PB+π, further executing the flow box 10, and outputting the Sagnac phase shift measurement value

$${ϕ}_{s} ( k ) = {tan}^{- 1} ( \frac{{S}_{1} ( k )}{{S}_{2} ( k )} ) + PB ,$$

if S₁(k−1)S₂(k−1) is not greater than 0, directly outputting the Sagnac phase shift measurement value

$${ϕ}_{s} ( k ) = {tan}^{- 1} ( \frac{{S}_{1} ( k )}{{S}_{2} ( k )} ) + PB ;$$

for the judgment box 11, if S₁(k−1)S₂(k−1) is less than 0, executing the flow box 12, updating parameter PB as PB−π, further executing the flow box 10, and outputting the Sagnac phase shift measurement value

$${ϕ}_{s} ( k ) = {tan}^{- 1} ( \frac{{S}_{1} ( k )}{{S}_{2} ( k )} ) + PB ,$$

if S₁(k−1)S₂(k−1) is not less than 0, directly outputting the Sagnac phase shift measurement value

$${ϕ}_{s} ( k ) = {tan}^{- 1} ( \frac{{S}_{1} ( k )}{{S}_{2} ( k )} ) + PB .$$

In the tracking phase in STEP 2, besides solution 1 shown in FIG. 2, solution 2 shown in FIG. 3 also can be used for achieving tracking of Sagnac phase shift. Solution 2: for k=k+1, k=0, 1, 2 . . . , executing the Sagnac phase shift tracking algorithm shown in the flow chart of FIG. 3: initial parameters in the tracking step are also set in the initialization phase STEP 1, the tracking algorithm also executes judgment by getting values from a function that is formed by the primary and secondary harmonic demodulation signals at the current time and the primary and secondary harmonic demodulation signals at the previous time (achieves by judgment boxes 6, 7, 8, 11, 15 and 16), and determines the update value of phase offset at each step of tracking and the Sagnac phase shift measurement value at each time (achieves by flow boxes 9, 10, 12, 13 and 14); first, judging whether value of function S₁(k−1)S₂(k−1)S₁(k)S₂(k) is less than 0 in the judgment box 6, if so, executing operation of judgment box 7, that is, judging whether value of function S₁(k)S₂(k−1)−S₂(k)S₁(k−1) is greater than 0, if it is not greater than 0, executing operation of judgment box 15, that is, judging whether |S₁(k)| is greater than |S₂(k)|; if S₁(k)S₂(k−1)−S₂(k)S₁(k−1) is greater than 0, executing operation of judgment box 8, otherwise, executing operation of judgment box 11; for the judgment box 8, if S₁(k−1)S₂(k−1) is greater than 0, executing the flow box 9, updating parameter PB as PB+π, further executing the flow box 13, and outputting the Sagnac phase shift measurement value

$${ϕ}_{s} ( k ) = - \frac{π}{2} - {tan}^{- 1} ( \frac{{S}_{2} ( k )}{{S}_{1} ( k )} ) + PB ,$$

if S₁(k−1)S₂(k−1) is not greater than 0, outputting the Sagnac phase shift measurement value

$${ϕ}_{s} ( k ) = {tan}^{- 1} ( \frac{{S}_{1} ( k )}{{S}_{2} ( k )} ) + PB ;$$

for the judgment box 11, if S₁(k−1)S₂(k−1) is less than 0, executing the flow box 12, updating parameter PB as PB−π, further executing the flow box 14, and outputting the Sagnac phase shift measurement value

$${ϕ}_{s} ( k ) = \frac{π}{2} - {tan}^{- 1} ( \frac{{S}_{2} ( k )}{{S}_{1} ( k )} ) + PB ,$$

if S₁(k−1)S₂(k−1) is not less than 0, outputting the Sagnac phase shift measurement value

$${ϕ}_{s} ( k ) = {tan}^{- 1} ( \frac{{S}_{1} ( k )}{{S}_{2} ( k )} ) + PB ;$$

for the judgment box 15, if |S₁(k)|>|S₂(k)|, executing operation of judgment box 16 and judging whether S₁(k) is greater than 0, otherwise, executing the flow box 10 and outputting the Sagnac phase shift measurement value

$${ϕ}_{s} ( k ) = {tan}^{- 1} ( \frac{{S}_{1} ( k )}{{S}_{2} ( k )} ) + PB ;$$

for the judgment box 16, if S₁(k)>0, executing operation of flow box 14 and outputting the Sagnac phase shift measurement value

$${ϕ}_{s} ( k ) = \frac{π}{2} - {tan}^{- 1} ( \frac{{S}_{2} ( k )}{{S}_{1} ( k )} ) + PB ,$$

otherwise, executing operation of flow box 13 and outputting the Sagnac phase shift measurement value

$${ϕ}_{s} ( k ) = - \frac{π}{2} - {tan}^{- 1} ( \frac{{S}_{2} ( k )}{{S}_{1} ( k )} ) + PB .$$

The core concept of the tracking phase is to judge the quadrant of Sagnac phase shift according to historical data of S₁ and S₂, and determine the basic angle value according to the current measurement results of S₁ and S₂. Based on this concept, the technique introduced here provides two different embodiments; those skilled in the art can provide other through slight modification. It should be noted that any tracking principle proposed in basis of this patent application for expanding the dynamic range of fiber-optic gyroscopes shall fall into the protection scope of the present invention.

The invention proposes a novel method for expanding the dynamic range of open-loop fiber-optic gyroscopes and increasing the scale factor linearity, namely, Sagnac phase shift tracking method. The method is a recurrence algorithm; it judges the quadrant of Sagnac phase shift by the primary and secondary harmonic waves demodulation signals at the current time and at the previous time, and makes the Sagnac phase shift monotone interval corresponding to the system revolving angular-velocity that can be measured by the open-loop fiber-optic gyroscopes break through [−π/2 π/2) and reach the measurement range of closed-loop fiber-optic gyroscopes. When Sagnac phase shift tracking is used, the dynamic range of open-loop fiber-optic gyroscopes is no longer limited to the dimension parameters of coils, and the sensitivity and precision of gyroscopes can be further improved at the same time greatly expanding the dynamic range. The method is a signal processing method that can be applied at the backend of the detector, it does not involve changes in term of structure of open-loop gyroscopes and related hardware functions, therefore the derived novel fiber-optic gyroscopes can have advantages of both traditional open-loop and closed-loop gyroscopes with extremely highly practical value.

Compared with the prior art, the invention has the following advantageous effects:

The signal processing method according to the invention makes the Sagnac phase shift monotone interval corresponding to the system revolving angular-velocity that can be measured by the fiber-optic gyroscopes completely break through [−π/2 π/2), expands it to each quadrant, and makes the dynamic range of open-loop fiber-optic gyroscopes reach the level of closed-loop fiber-optic gyroscopes, without changing the structure of open-loop fiber-optic gyroscopes shown in FIG. 1 and functions of elements (the phase modulator still works under normal state), that is, without increasing the complexity of hardware.

When the method is used, the dynamic range of open-loop fiber-optic gyroscopes is no longer related to the dimension parameters of coils, which paves the way for further improving the precision and scale factor linearity, thus the derived novel fiber-optic gyroscopes can have advantages of both traditional open-loop fiber-optic gyroscopes and closed-loop fiber-optic gyroscopes.

### BRIEF DESCRIPTION OF THE DRAWINGS

FIG. 1 illustrates a basic structure of an open-loop fiber-optic gyroscope;

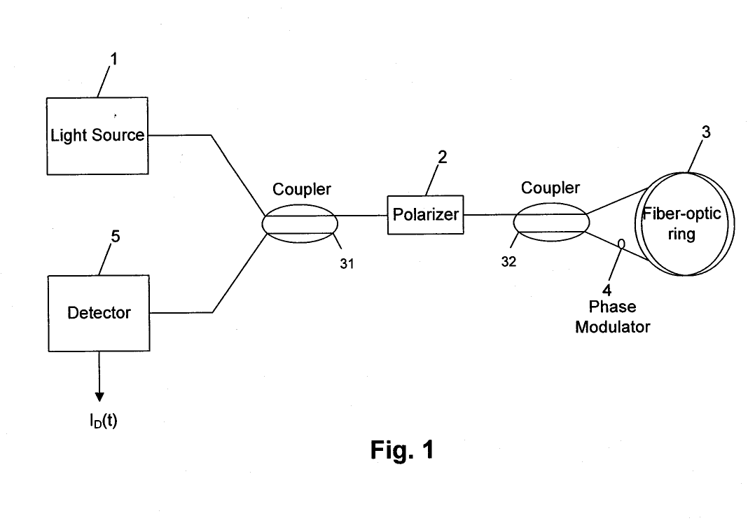

FIG. 2 illustrates a flow chart (Solution 1) of a tracking phase of Sagnac phase shift tracking algorithm;

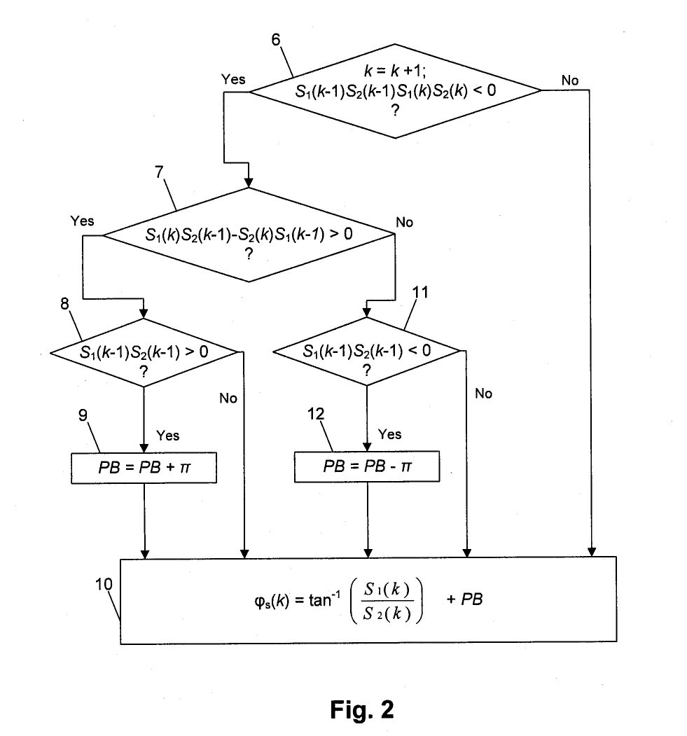

FIG. 3 illustrates a flow chart (Solution 2) of a tracking phase of Sagnac phase shift tracking algorithm;

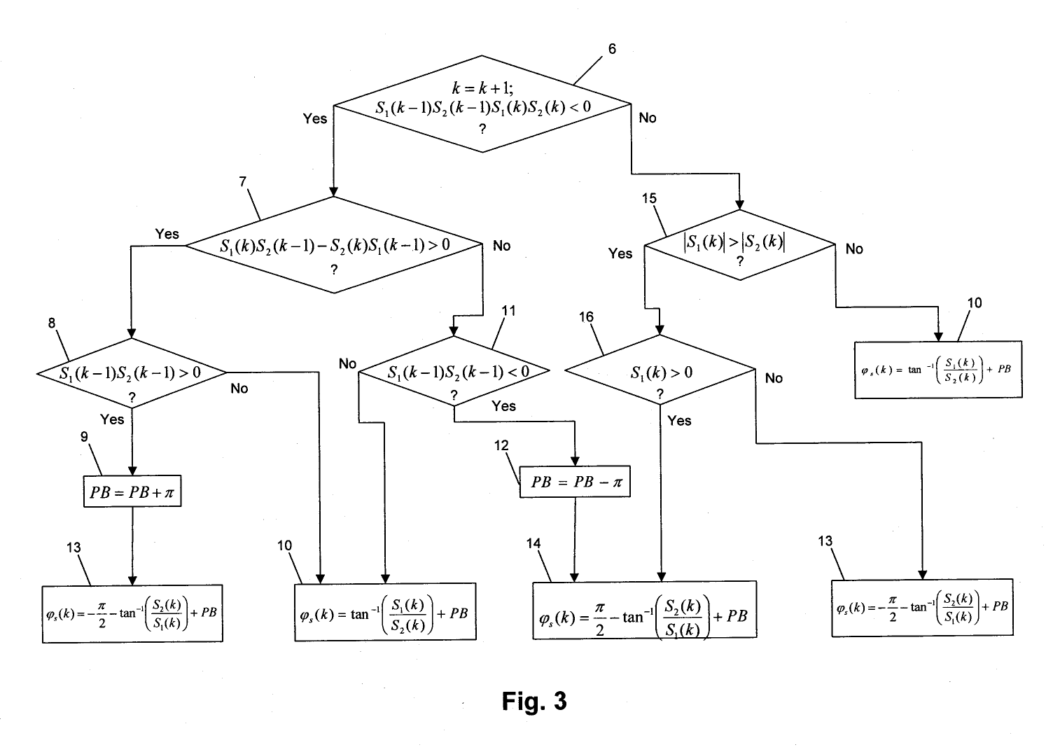

FIG. 4 illustrates an implementation of Sagnac phase shift tracking based on digital demodulation; and

FIG. 5 illustrates an implementation of Sagnac phase shift tracking based on analog demodulation;

wherein the following reference numerals apply: 1—laser light source, 2—polarizer, 3—fiber-optic ring, 4—phase modulator, 5—detector; 6, 7, 8, 11, 15 and 16 are conditional judgment boxes; 9, 10, 12, 13 and 14 are flow boxes; 17—amplification, filtering and analog-to-digital conversion module, 18—signal processing module, 19—digital-to-analog conversion module, 20—amplification and filtering module, 21—primary harmonic wave demodulation module, 22—secondary harmonic demodulation module, 23—analog-to-digital conversion module, 24—signal processing module, 25—oscillator, 26—90° phase shift and frequency multiplication module; 31—coupler; and 32—coupler.

### DETAILED DESCRIPTION

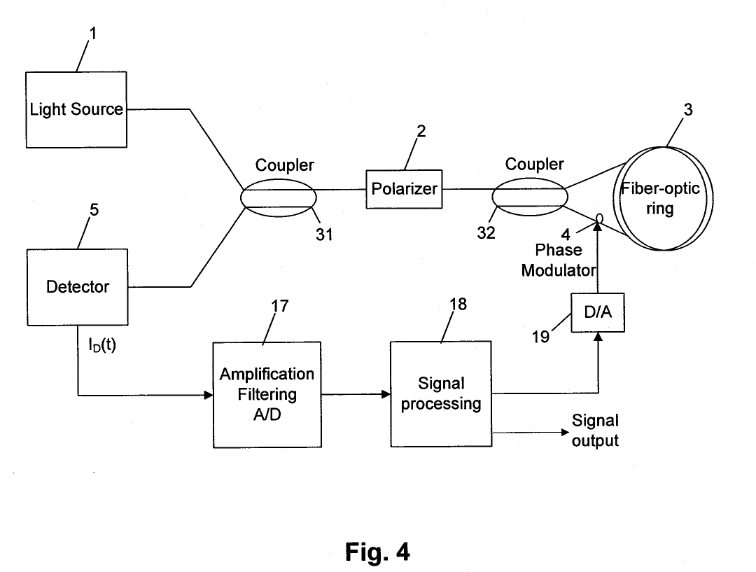

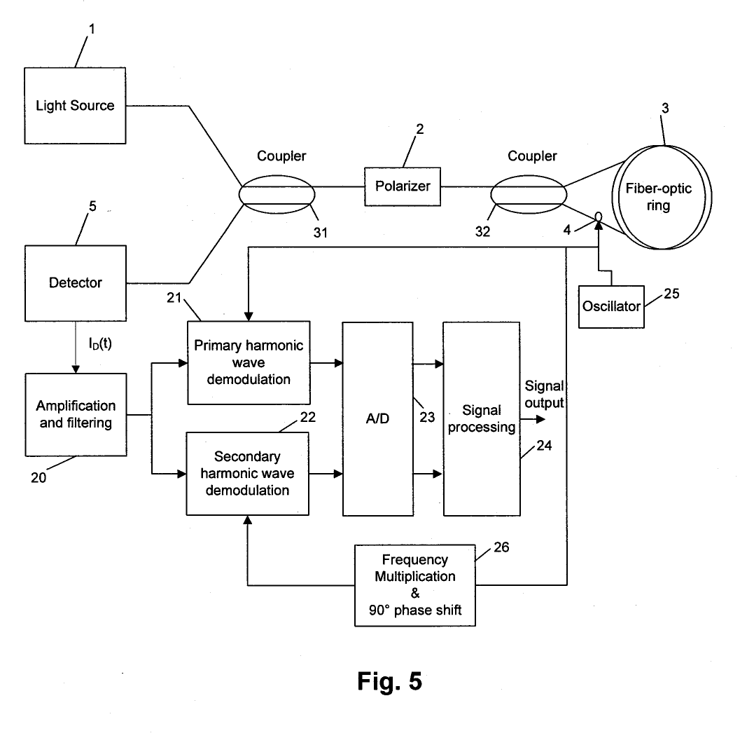

The implementations of the invention will be described in detail below in combination with FIG. 4 and FIG. 5.

The schematic block diagram of the first implementation of the invention is shown as FIG. 4; the analog signal I_{D}(t) output from the detector is input to module 17, first amplified and then low-pass filtered, the function of filtering is to filter tertiary or higher harmonic wave signals in the detection signal I_{D}(t) and suppress noise at the same time. The filtered signal is ND sampled and then input to the signal processing module 18. In the module 18, digital demodulation is first carried out to execute demodulation on the primary harmonic wave signal and secondary harmonic wave signal on the input signal, the primary harmonic wave demodulation signal is proportional to sin φₛ(k) and the secondary harmonic demodulation signal is proportional to cos φₛ(k), scale factors are obtained by tests and then processed to obtain the primary and secondary harmonic signals S₁(k) and S₂(k), k=0, 1, 2 . . . . The obtained demodulation signals are processed with Sagnac phase shift tracking algorithm given in the principle part of the invention (please refer to specific description in STEP 1 and STEP 2), and finally, the processed data, namely, the measurement value of Sagnac phase shift, is output. Module 18 also outputs digital signals to control D/A converter shown as module 19 to make it output analog signals with the same frequency as the primary harmonic wave signal in order to control the phase modulator in the coils.

The schematic block diagram of the second implementation of the invention is shown as FIG. 5; the analog signal I_{D}(t) output from the detector is input to module 20 to be amplified and band-pass filtered, band-pass filtering is to filter DC signals and tertiary or higher harmonic wave signals in the detection signal. The amplified and filtered signals are divided into two paths to execute demodulations on the analog primary harmonic wave signal (as shown in module 21) and the secondary harmonic signal (as shown in module 22), respectively. It should be noted that two parallel band-pass filters can be arranged behind the amplifier to respectively filter the primary and secondary harmonic wave signals, and then demodulations on analog primary harmonic wave signal (as shown in module 21) and secondary harmonic signal (as shown in module 22) are executed respectively. The two paths of demodulated signals are input to module 23 to execute A/D sampling, the sampled signals are input to module 24 to execute signal processing. As described above, the primary harmonic wave demodulation signal is proportional to sin φₛ(k) and the secondary harmonic demodulation signal is proportional to cos φₛ(k), module 24 first obtains scale factors by tests to process the demodulated signals to obtain S₁(k) and S₂(k), k=0, 1, 2 . . . , then executes Sagnac phase shift tracking algorithm given in the principle part of the invention (see STEP 1 and STEP 2) on the obtained demodulation signals, and finally outputs the measurement value of Sagnac phase shift. In this solution, the phase modulator in coils is controlled by the oscillator shown as module 25, demodulation signals are generated by signals from the oscillator, and the primary harmonic wave demodulation and secondary harmonic wave demodulation of module 21 and module 22 are controlled at the same time.

What is claimed is:

1. A method for determining a Sagnac phase shift of a fiber-optic gyroscope, the method comprising:
determining, for both a current time and a previous time, a value of a primary harmonic demodulated signal and a value of a secondary harmonic demodulated signal from a detector output in the fiber-optic gyroscope; and
determining the Sagnac phase shift of the fiber-optic gyroscope for the current time based on the values of the primary harmonic demodulated signal and the secondary harmonic demodulated signal for both the current time and the previous time.

2. A method as recited in claim 1, wherein the fiber-optic gyroscope is an open-loop fiber-optic gyroscope, and wherein the Sagnac phase shift monotone interval is not limited to the interval [−π/2 π/2).

3. A method as recited in claim 1, wherein determining the Sagnac phase shift of the fiber-optic gyroscope for the current time comprises:
computing a phase offset value; and
determining the Sagnac phase shift for the current time based on the phase offset value and the values of the primary harmonic demodulated signal and the secondary harmonic demodulated signal for the current time.

4. A method as recited in claim 3, wherein determining the Sagnac phase shift of the fiber-optic gyroscope for the current time comprises computing an arc-tangent of a ratio of the values of the primary harmonic demodulated signal and the secondary harmonic demodulated signal for the current time; and
wherein determining the Sagnac phase shift for the current time comprises determining the Sagnac phase shift for the current time based on the phase offset value and the arc-tangent of the ratio of the values of the primary harmonic demodulated signal and the secondary harmonic demodulated signal for the current time.

5. A method as recited in claim 3, wherein computing the phase offset value comprises:
determining whether the Sagnac phase shift for the current time has moved to a different quadrant compared with the Sagnac phase shift for the previous time; and
computing the phase offset value according to whether the Sagnac phase shift for the current time has moved to a different quadrant compared with the Sagnac phase shift for the previous time.

6. A method as recited in claim 5, wherein computing the phase offset value according to whether the Sagnac phase shift for the current time has moved to a different quadrant compared with the Sagnac phase shift for the previous time comprises:
if the Sagnac phase shift for the current time has not moved to a different quadrant compared with the Sagnac phase shift for the previous time, or the Sagnac phase shift for the current time has moved to a different quadrant compared with the Sagnac phase shift for the previous time yet the quadrant pair of (current time, previous time) is one of (quadrant I, quadrant IV), (quadrant IV, quadrant I), (quadrant II, quadrant III) and (quadrant III, quadrant II), then not updating the phase offset value; and
if the Sagnac phase shift for the current time has moved to a different quadrant compared with the Sagnac phase shift for the previous time and the quadrant pair of (current time, previous time) is one of (quadrant I, quadrant II), (quadrant II, quadrant I), (quadrant III, quadrant IV) and (quadrant IV, quadrant III), then updating the phase offset value.

7. A method as recited in claim 6, wherein updating the phase offset value comprises adding or subtracting a value of π to a previously computed phase offset value.

8. An open-loop fiber-optic gyroscope comprising:
a light source;
a fiber-optic ring optically coupled to the light source;
a detector optically coupled to the fiber-optic ring; and
a processor to determine, based on an output of the detector, a Sagnac phase shift of the open-loop fiber-optic gyroscope, such that the Sagnac phase shift monotone interval of the open-loop fiber-optic gyroscope is not limited to the interval [−π/2 π/2).

9. An open-loop fiber-optic gyroscope as recited in claim 8, wherein the processor is configured to:
determine, for both a current time and a previous time, a value of a primary harmonic demodulated signal and a value of a secondary harmonic demodulated signal from the output of the detector; and
determine the Sagnac phase shift of the open-loop fiber-optic gyroscope for the current time based on the values of the primary harmonic demodulated signal and the secondary harmonic demodulated signal for both the current time and the previous time.

10. An open-loop fiber-optic gyroscope as recited in claim 8, wherein determining the Sagnac phase shift of the open-loop fiber-optic gyroscope for the current time comprises:
computing a phase offset value; and
determining the Sagnac phase shift for the current time based on the phase offset value and the values of the primary harmonic demodulated signal and the secondary harmonic demodulated signal for the current time.

11. An open-loop fiber-optic gyroscope as recited in claim 10, wherein determining the Sagnac phase shift of the open-loop fiber-optic gyroscope for the current time comprises computing an arc-tangent of a ratio of the values of the primary harmonic demodulated signal and the secondary harmonic demodulated signal for the current time; and
wherein determining the Sagnac phase shift for the current time comprises determining the Sagnac phase shift for the current time based on the phase offset value and the arc-tangent of the ratio of the values of the primary harmonic demodulated signal and the secondary harmonic demodulated signal for the current time.

12. An open-loop fiber-optic gyroscope as recited in claim 10, wherein computing the phase offset value comprises:
determining whether the Sagnac phase shift for the current time has moved to a different quadrant compared with the Sagnac phase shift for the previous time; and
computing the phase offset value according to whether the Sagnac phase shift for the current time has moved to a different quadrant compared with the Sagnac phase shift for the previous time.

13. An open-loop fiber-optic gyroscope as recited in claim 12, wherein computing the phase offset value according to whether the Sagnac phase shift for the current time has moved to a different quadrant compared with the Sagnac phase shift for the previous time comprises:
if the Sagnac phase shift for the current time has not moved to a different quadrant compared with the Sagnac phase shift for the previous time or the Sagnac phase shift for the current time has moved to a different quadrant compared with the Sagnac phase shift for the previous time yet the quadrant pair of (current time, previous time) is one of (quadrant I, quadrant IV), (quadrant IV, quadrant I), (quadrant II, quadrant III) and (quadrant III, quadrant II), then not updating the phase offset value; and
if the Sagnac phase shift for the current time has moved to a different quadrant compared with the Sagnac phase shift for the previous time and the quadrant pair of (current time, previous time) is one of (quadrant I, quadrant II), (quadrant II, quadrant I), (quadrant III, quadrant IV) and (quadrant IV, quadrant III), then updating the phase offset value.

14. An open-loop fiber-optic gyroscope as recited in claim 13, wherein updating the phase offset value comprises adding or subtracting a value of π to a previously computed phase offset value.

15. A fiber-optic gyroscope comprising:
a polarizer;
a fiber-optic ring;
a first coupler;
a second coupler;
a laser light source coupled with the polarizer through the first coupler, the polarizer coupled with the fiber-optic ring through the second coupler;
a detector;
a signal processing module;
a filtering and analog-to-digital conversion module;
a digital-to-analog conversion module; and
a phase modulator coupled between the fiber-optic ring and the second coupler, a port of the second coupler being coupled with the detector, the detector and the laser light source being positioned at a same side of the first coupler, an output end of the detector being coupled with a control end of the phase modulator through the filtering and analog-to-digital conversion module, the signal processing module and the digital-to-analog conversion module;
wherein the signal processing module is configured to perform a Sagnac phase shift tracking process that includes:
determining, for both a current time and a previous time, a value of a primary harmonic demodulated signal and a value of a secondary harmonic demodulated signal from a detector output in the fiber-optic gyroscope; and
determining the Sagnac phase shift of the fiber-optic gyroscope for the current time based on the values of the primary harmonic demodulated signal and the secondary harmonic demodulated signal for both the current time and the previous time.

16. A fiber-optic gyroscope as recited in claim 15, wherein the Sagnac phase shift tracking process comprises:
filtering and demodulating a detection signal sampled at time of k=0 to obtain a primary harmonic wave demodulation signal S₁(0) and a secondary harmonic demodulation signal S₂(0) of the detection signal at time of k=0, wherein k is a time of sampling;
calculating to obtain a Sagnac phase shift φₛ(0) of the fiber-optic gyroscope at time of k=0 according to S₁(0) and S₂(0), and initializing an initial value of a phase offset parameter PB as 0;
filtering and demodulating a detection signal sampled at a subsequent time k to obtain a primary harmonic wave demodulation signal S₁(k) and a second harmonic demodulation signal S₂(k) at a current time; and
determining the Sagnac phase shift value φₛ(k) at the current time according to S₁(k) and S₂(k) as well as the primary harmonic wave demodulation signal S₁(k−1) and the secondary harmonic demodulation signal S₂(k−1) at the previous time.

17. A fiber-optic gyroscope as recited in claim 16, wherein the process for determining the Sagnac phase shift value φₛ(k) at the current time comprises:
a) first, judging whether S₁(k−1)S₂(k−1)S₁(k)S₂(k) is less than 0, if so, carrying out Step b), otherwise, directly outputting the Sagnac phase shift measurement value
$${ϕ}_{s} ( k ) = {tan}^{- 1} ( \frac{{S}_{1} ( k )}{{S}_{2} ( k )} ) + PB ;$$
b) if S₁(k)S₂(k−1)−S₂(k)S₁(k−1) is greater than 0, when S₁(k−1)S₂(k−1) is greater than 0, updating the parameter PB as PB+π and then outputting
$${ϕ}_{s} ( k ) = {tan}^{- 1} ( \frac{{S}_{1} ( k )}{{S}_{2} ( k )} ) + PB ,$$
otherwise directly outputting
$${ϕ}_{s} ( k ) = {tan}^{- 1} ( \frac{{S}_{1} ( k )}{{S}_{2} ( k )} ) + PB ;$$
if S₁(k)S₂(k−1)−S₂(k)S₁(k−1) is not greater than 0, when S₁(k−1)S₂(k−1) is less than 0, updating the parameter PB as PB−π and then outputting
$${ϕ}_{s} ( k ) = {tan}^{- 1} ( \frac{{S}_{1} ( k )}{{S}_{2} ( k )} ) + PB ,$$
otherwise, directly outputting
$${ϕ}_{s} ( k ) = {tan}^{- 1} ( \frac{{S}_{1} ( k )}{{S}_{2} ( k )} ) + PB .$$

18. A fiber-optic gyroscope as recited in claim 16, wherein determining the Sagnac phase shift value φₛ(k) at the current time comprises:
a) first, judging whether S₁(k−1)S₂(k−1)S₁(k)S₂(k) is less than 0, if so, carrying out Step b), otherwise, carrying out Step c);
b) if S₁(k)S₂(k−1)−S₂(k)S₁(k−1) is greater than 0, when S₁(k−1)S₂(k−1) is greater than 0, updating the parameter PB as PB+π and then outputting
$${ϕ}_{s} ( k ) = - \frac{π}{2} - {tan}^{- 1} ( \frac{{S}_{2} ( k )}{{S}_{1} ( k )} ) + PB ,$$
otherwise directly outputting
$${ϕ}_{s} ( k ) = {tan}^{- 1} ( \frac{{S}_{1} ( k )}{{S}_{2} ( k )} ) + PB ;$$
if S₁(k)S₂(k−1)−S₂(k)S₁(k−1) is not greater than 0, when S₁(k−1)S₂(k−1) is less than 0, updating the parameter PB as PB−π and then outputting
$${ϕ}_{s} ( k ) = \frac{π}{2} - {tan}^{- 1} ( \frac{{S}_{2} ( k )}{{S}_{1} ( k )} ) + PB ,$$
otherwise, directly outputting
$${ϕ}_{s} ( k ) = {tan}^{- 1} ( \frac{{S}_{1} ( k )}{{S}_{2} ( k )} ) + PB ;$$
c) if |S₁(k)|>|S₂(k)|, when S₁(k) is greater than 0, outputting
$${ϕ}_{s} ( k ) = \frac{π}{2} - {tan}^{- 1} ( \frac{{S}_{2} ( k )}{{S}_{1} ( k )} ) + PB ,$$
otherwise, directly outputting
$${ϕ}_{s} ( k ) = - \frac{π}{2} - {tan}^{- 1} ( \frac{{S}_{2} ( k )}{{S}_{1} ( k )} ) + PB ;$$
if |S₁(k)|≦|S₂(k)|, directly outputting
$${ϕ}_{s} ( k ) = {tan}^{- 1} ( \frac{{S}_{1} ( k )}{{S}_{2} ( k )} ) + PB .$$

19. A fiber-optic gyroscope as recited in claim 16, wherein the Sagnac phase shift φₛ(0) at time of k=0 is calculated according to a formula
$${ϕ}_{s} ( 0 ) = {tan}^{- 1} ( \frac{{S}_{1} ( 0 )}{{S}_{2} ( 0 )} ) .$$

20. A fiber-optic gyroscope as recited in claim 16, wherein the output end of the detector is coupled with the input end of the filtering and analog-to-digital conversion module through an amplifier.

21. A fiber-optic gyroscope comprising:
a polarizer;
a fiber-optic ring;
a first coupler;
a second coupler;
a laser light source coupled with the polarizer through the first coupler, the polarizer coupled with the fiber-optic ring through a second coupler;
a detector;
a signal processing module;
a filter;
an analog-to-digital conversion module;
a primary harmonic wave demodulation module;
a secondary harmonic demodulation module;
an oscillator;
a 90° phase shift and frequency multiplication module; and
a phase modulator coupled between the fiber-optic ring and the second coupler;
wherein a port of the first coupler is coupled with a detector, the detector and the laser light source are positioned at a same side of the first coupler, an output end of the detector is coupled with an input end of the filter, an output end of the filter is coupled respectively with input ends of the primary harmonic wave demodulation module and the secondary harmonic demodulation module, wherein output ends of the primary harmonic wave demodulation module and the secondary harmonic demodulation module are coupled with the signal processing module through the analog-to-digital conversion module, control ends of the phase modulator and the primary harmonic wave demodulation module are coupled respectively with an output end of the oscillator; and a control end of the second harmonic demodulation module is coupled with an output end of the oscillator through the 90° phase shift and frequency multiplication module;
and wherein the signal processing module is configured to execute a Sagnac phase shift tracking process that includes:
determining, for both a current time and a previous time, a value of a primary harmonic demodulated signal and a value of a secondary harmonic demodulated signal from a detector output in the fiber-optic gyroscope; and
determining the Sagnac phase shift of the fiber-optic gyroscope for the current time based on the values of the primary harmonic demodulated signal and the secondary harmonic demodulated signal for both the current time and the previous time.

22. A fiber-optic gyroscope as recited in claim 21, wherein the Sagnac phase shift tracking process comprises:
filtering, demodulating a detection signal and sampling the demodulation signal at time of k=0 to obtain a primary harmonic wave demodulation signal S₁(0) and a secondary harmonic demodulation signal S₂(0) of the detection signal at time of k=0, wherein k is a time of sampling;
calculating to obtain a Sagnac phase shift φₛ(0) of the fiber-optic gyroscope at time of k=0 according to S₁(0) and S₂(0), and initializing an initial value of a phase offset parameter PB as 0;
filtering, demodulating a detection signal and sampling the demodulation signal at the subsequent time k to obtain a primary harmonic wave demodulation signal S₁(k) and a second harmonic demodulation signal S₂(k) at a current time; and
determining a Sagnac phase shift value φₛ(k) at the current time according to S₁(k) and S₂(k) as well as the primary harmonic wave demodulation signal S₁(k−1) and the secondary harmonic demodulation signal S₂(k−1) at the previous time.

23. A fiber-optic gyroscope as recited in claim 22, wherein the method for determining the Sagnac phase shift value φₛ(k) at the current time comprises:
a) first, judging whether S₁(k−1)S₂(k−1)S₁(k)S₂(k) is less than 0, if so, carrying out Step b), otherwise, directly outputting a Sagnac phase shift measurement value
$${ϕ}_{s} ( k ) = {tan}^{- 1} ( \frac{{S}_{1} ( k )}{{S}_{2} ( k )} ) + PB ;$$
b) if S₁(k)S₂(k−1)−S₂(k)S₁(k−1) is greater than 0, when S₁(k−1)S₂(k−1) is greater than 0, updating the parameter PB as PB+π and then outputting
$${ϕ}_{s} ( k ) = {tan}^{- 1} ( \frac{{S}_{1} ( k )}{{S}_{2} ( k )} ) + PB ,$$
otherwise directly outputting
$${ϕ}_{s} ( k ) = {tan}^{- 1} ( \frac{{S}_{1} ( k )}{{S}_{2} ( k )} ) + PB ;$$
if S₁(k)S₂(k−1)−S₂(k)S₁(k−1) is not greater than 0, when S₁(k−1)S₂(k−1) is less than 0, updating the parameter PB as PB−π and then outputting
$${ϕ}_{s} ( k ) = {tan}^{- 1} ( \frac{{S}_{1} ( k )}{{S}_{2} ( k )} ) + PB ,$$
otherwise, directly outputting
$${ϕ}_{s} ( k ) = {tan}^{- 1} ( \frac{{S}_{1} ( k )}{{S}_{2} ( k )} ) + PB .$$

24. A fiber-optic gyroscope as recited in claim 23, wherein the method for determining the Sagnac phase shift value φₛ(k) at the current time comprises:
a) first, judging whether S₁(k−1)S₂(k−1)S₁(k)S₂(k) is less than 0, if so, carrying out Step b), otherwise, carrying out Step c);
b) if S₁(k)S₂(k−1)−S₂(k)S₁(k−1) is greater than 0, when S₁(k−1)S₂(k−1) is greater than 0, updating the parameter PB as PB+π and then outputting
$${ϕ}_{s} ( k ) = - \frac{π}{2} - {tan}^{- 1} ( \frac{{S}_{2} ( k )}{{S}_{1} ( k )} ) + PB ,$$
otherwise directly outputting
$${ϕ}_{s} ( k ) = {tan}^{- 1} ( \frac{{S}_{1} ( k )}{{S}_{2} ( k )} ) + PB ;$$
if S₁(k)S₂(k−1)−S₂(k)S₁(k−1) is not greater than 0, when S₁(k−1)S₂(k−1) is less than 0, updating the parameter PB as PB−π and then outputting
$${ϕ}_{s} ( k ) = \frac{π}{2} - {tan}^{- 1} ( \frac{{S}_{2} ( k )}{{S}_{1} ( k )} ) + PB ,$$
otherwise, directly outputting
$${ϕ}_{s} ( k ) = {tan}^{- 1} ( \frac{{S}_{1} ( k )}{{S}_{2} ( k )} ) + PB ;$$
c) if |S₁(k)|>S₂(k)|, when S₁(k) is greater than 0, outputting
$${ϕ}_{s} ( k ) = \frac{π}{2} - {tan}^{- 1} ( \frac{{S}_{2} ( k )}{{S}_{1} ( k )} ) + PB ,$$
otherwise, directly outputting
$${ϕ}_{s} ( k ) = - \frac{π}{2} - {tan}^{- 1} ( \frac{{S}_{2} ( k )}{{S}_{1} ( k )} ) + PB ;$$
if |S₁(k)|≦S₂(k)|, directly outputting
$${ϕ}_{s} ( k ) = {tan}^{- 1} ( \frac{{S}_{1} ( k )}{{S}_{2} ( k )} ) + PB .$$

25. A fiber-optic gyroscope as recited in claim 23, wherein the Sagnac phase shift φₛ(0) at time of k=0 is calculated according to a formula
$${ϕ}_{s} ( 0 ) = {tan}^{- 1} ( \frac{{S}_{1} ( 0 )}{{S}_{2} ( 0 )} ) .$$

26. A fiber-optic gyroscope as recited in claim 23, wherein the output end of the detector is coupled with the input end of the filter through an amplifier.
